(19) United States
(12) Patent Application Publication
(10) Pub. No.: US 2016/0102777 A1
(43) Pub. Date: Apr. 14, 2016

(54) Water Spigot Safety Device

(71) Applicant: Daniel R. Robles, Lancaster, CA (US)

(72) Inventor: Daniel R. Robles, Lancaster, CA (US)

(21) Appl. No.: 14/509,819

(22) Filed: Oct. 8, 2014

(51) Int. Cl. F16K 35/10

(52) U.S. Cl. CPC F16K 35/10

(57) ABSTRACT

A water spigot safety device prevents the unauthorized use of water from a water spigot. The device includes a cover having a top wall and a perimeter wall coupled to and extending downwardly from the top wall. A front side of the cover has a first notch therein. A rear side of the cover has a second notch extending positioned opposite the first notch. Each of the first and second notches extends upwardly from a bottom end of the perimeter wall. The cover is positionable over a water spigot such that an arm of the water spigot is extendable through the first notch, a spout of the water spigot is extendable through the second notch and a handle of the water spigot is extendable into an interior space of the cover. A locking member is coupled to the cover for securing the handle within the interior space of the cover.

### BACKGROUND OF THE DISCLOSURE

### Field of the Disclosure

The disclosure relates to anti-theft devices and more particularly pertains to a new anti-theft device for preventing the unauthorized use of water from an outdoor water spigot.

### SUMMARY OF THE DISCLOSURE

An embodiment of the disclosure meets the needs presented above by generally comprising a cover having a top wall and a perimeter wall coupled to and extending downwardly from the top wall. A front side of the cover has a first notch extending therein. A rear side of the cover has a second notch extending therein positioned opposite the first notch. Each of the first and second notches extends upwardly from a bottom end of the perimeter wall. The cover is positionable over a water spigot such that an arm of the water spigot is extendable through the first notch, a spout of the water spigot is extendable through the second notch and a handle of the water spigot is extendable into an interior space of the cover. A locking member is coupled to the cover for securing the handle within the interior space of the cover.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a water spigot safety device according to an embodiment of the disclosure.

FIG. 2 is a front view of an embodiment of the disclosure.

FIG. 3 is a bottom view of an embodiment of the disclosure.

FIG. 4 is a cross-sectional view of an embodiment of the disclosure taken along line 4-4 of FIG. 3.

FIG. 5 is an in-use side view of an embodiment of the disclosure.

### DESCRIPTION OF THE PREFERRED EMBODIMENT

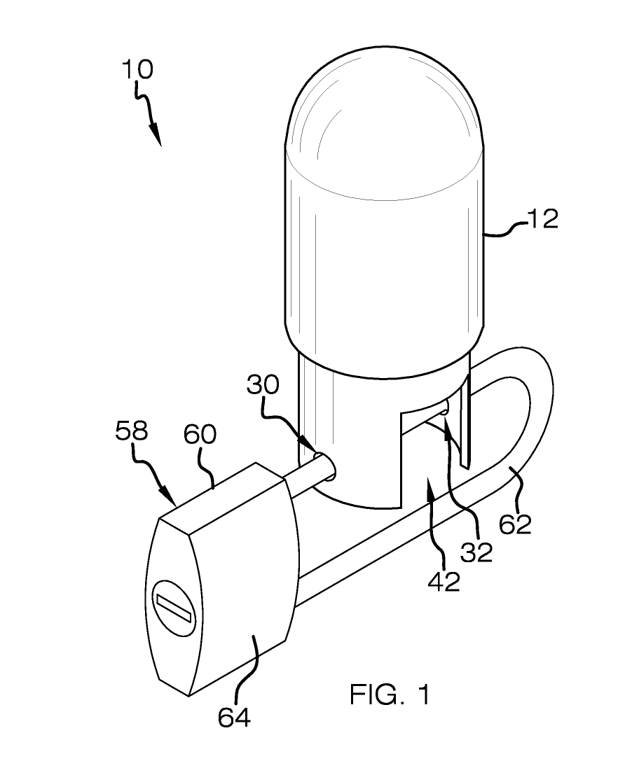

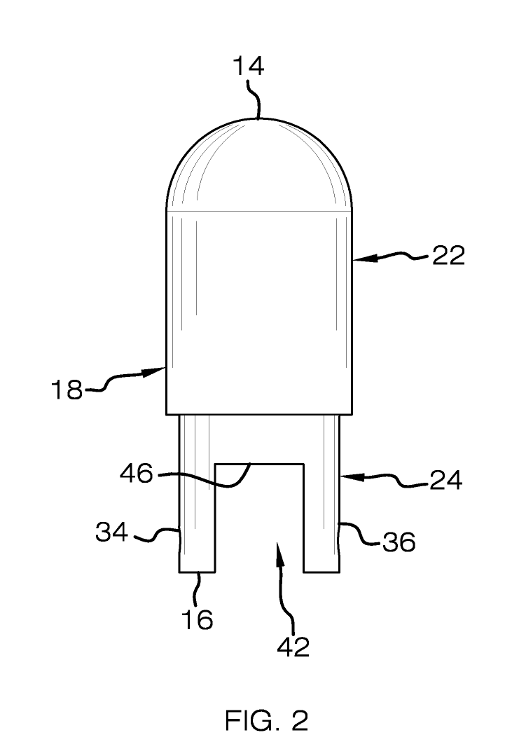

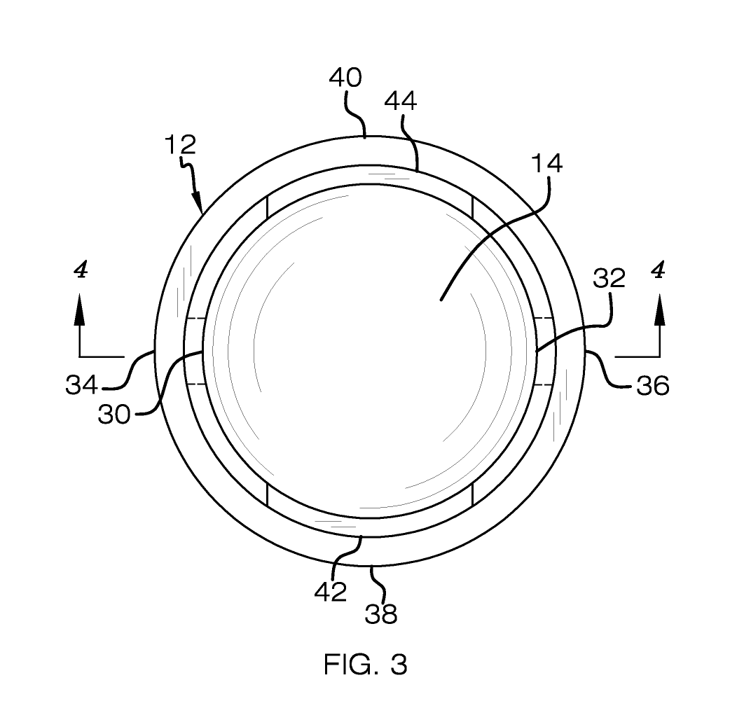

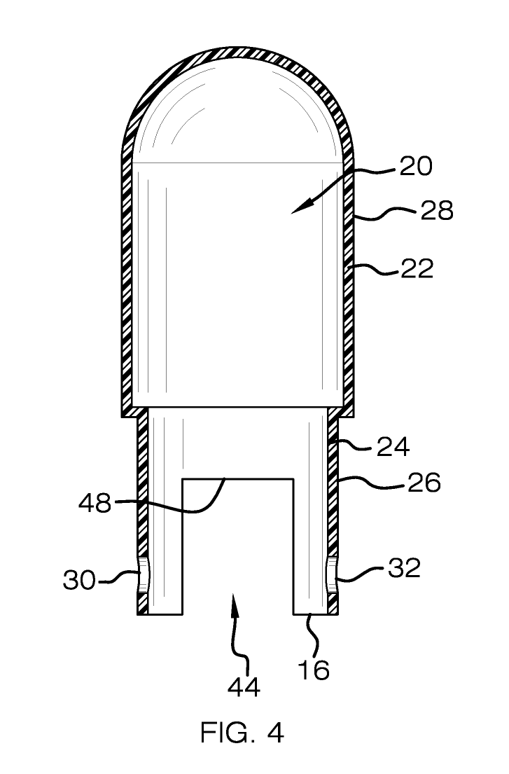

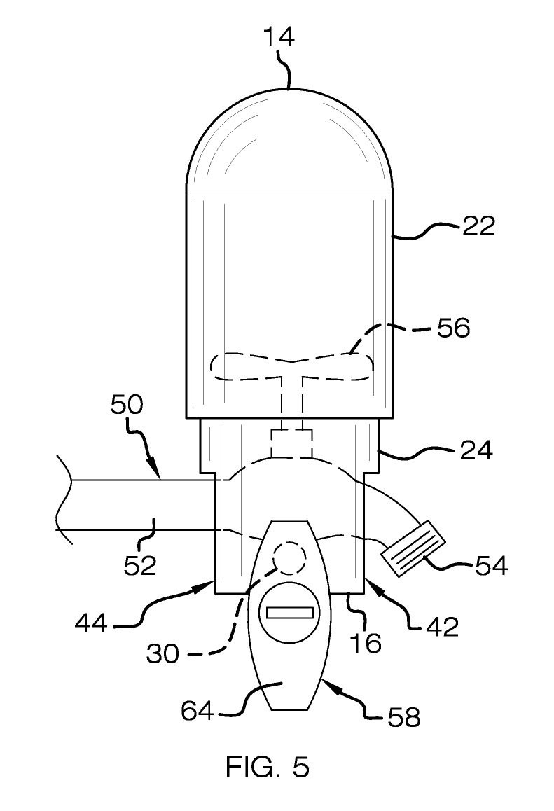

With reference now to the drawings, and in particular to FIGS. 1 through 5 thereof, a new anti-theft device embodying the principles and concepts of an embodiment of the disclosure and generally designated by the reference numeral 10 will be described.

As best illustrated in FIGS. 1 through 5, the water spigot safety device 10 generally comprises a cover 12 having a top wall 14 and a perimeter wall 18 coupled to and extending downwardly from the top wall 14 defining an interior space 20 of the cover 12. The top wall 14 is closed. A bottom end 16 of the perimeter wall 18 provides access to the interior space 20 of the cover 12. The top wall 14 may be convexly arcuate. The cover 12 includes a top section 22 and a bottom section 24, which may be integrally coupled together. An outer surface 26 of the bottom section 24 is inset relative to an exterior surface 28 of the top section 22. The top section 22 may be dome-shaped, and the bottom section 24 may be cylindrical. The cover 12 is comprised of a rigid material, such as plastic, metal or the like. A distance from the bottom end 16 to the top wall 14 may measure between approximately 8.0 cm and 20.0 cm.

The perimeter wall 18 has a pair of openings 30, 32 extending therein. One of the openings 30, 32 is positioned in a first lateral side 34 of the cover 12. One of the openings 30, 32 is positioned in a second lateral side 36 of the cover 12. The first 34 and second 36 lateral sides of the cover 12 are coupled to and extend between a front side 38 and a rear side 40 of the cover 12. A distance from the front side 38 to the rear side 40 may measure between approximately 5.0 cm and 8.5 cm.

The front side 38 of the cover 12 has a first notch 42 extending therein. The first notch 42 extends upwardly from the bottom end 16. The rear side 40 of the cover 12 has a second notch 44 extending therein. The second notch 44 extends upwardly from the bottom end 16 and is positioned opposite the first notch 42. Each of the first notch 42 and the second notch 44 has a respective top edge 46, 48 positioned distally relative to the bottom end 16 of the cover 12. Each of the openings 30, 32 is spaced below the respective top edge 46, 48 of the first 42 and second 44 notches. The first notch 42 and the second notch 44 may each be rectangular. The cover 12 is configured for positioning over a water spigot 50 such that an arm 52 of the water spigot 50 is extendable through the first notch 42, a spout 54 of the water spigot 50 is extendable through the second notch 44 and a handle 56 of the water spigot 50 is extendable into the interior space 20 of the cover 12.

A locking member 58 is coupled to the cover 12 wherein the locking member 58 is configured for securing the handle 56 of the water spigot 50 within the interior space 20 of the cover 12. The locking member 58 may comprise a padlock 60 removably coupled to the cover 12. The padlock 60 may be generally conventional and include a shackle 62 and a main body 64 coupled together. The shackle 62 is extendable through each of the openings 30, 32 to secure the locking member 58 to the cover 12.

In use, the cover 12 is positioned over the handle 56 of a water spigot 50. The locking member 58 is coupled to the cover 12 by inserting the shackle 62 through each of the openings 30, 32. In this manner, the device 10 prevents theft of water from the water spigot 50 and limits use of the water spigot 50 to authorized users.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A water spigot safety device comprising:
a cover having a top wall and a perimeter wall coupled to and extending downwardly from said top wall defining an interior space of said cover, said top wall being closed, a bottom end of said perimeter wall providing access to said interior space of said cover;
a front side of said cover having a first notch extending therein, said first notch extending upwardly from said bottom end;
a rear side of said cover having a second notch extending therein, said second notch being positioned opposite said first notch, said second notch extending upwardly from said bottom end;
wherein said cover is configured for positioning over a water spigot such that an arm of the water spigot is extendable through said first notch, a spout of the water spigot is extendable through said second notch and a handle of the water spigot is extendable into said interior space of said cover; and
a locking member coupled to said cover wherein said locking member is configured for securing the handle of the water spigot within said interior space of said cover.

2. The device of claim 1, further comprising said top wall of said cover being convexly arcuate.

3. The device of claim 1, further comprising said cover including a top section coupled to a bottom section.

4. The device of claim 3, further comprising an outer surface of said bottom section being inset relative to an exterior surface of said top section.

5. The device of claim 3, further comprising said top section being dome-shaped.

6. The device of claim 3, further comprising said top section and said bottom section being integrally coupled together.

7. The device of claim 3, further comprising said bottom section being cylindrical.

8. The device of claim 1, further comprising:
said perimeter wall of said cover having a pair of openings extending therein; and
said locking member comprising a padlock removably coupled to said cover, said padlock including a shackle and a main body coupled together, said shackle being extendable through each of said openings.

9. The device of claim 8, further comprising:
one of said openings being positioned in a first lateral side of said cover, one of said openings being positioned in a second lateral side of said cover, said first and second lateral sides of said cover being coupled to and extending between said front and rear sides of said cover;
each of said first notch and said second notch having a respective top edge positioned distally relative to said bottom end of said cover, each of said openings being spaced below said respective top edge of said first and second notches.

10. The device of claim 1, further comprising each of said first notch and said second notch being rectangular.

11. A water spigot safety device comprising:
a cover having a top wall and a perimeter wall coupled to and extending downwardly from said top wall defining an interior space of said cover, said top wall being closed, a bottom end of said perimeter wall providing access to said interior space of said cover, said top wall being convexly arcuate, said cover including a top section coupled to a bottom section, an outer surface of said bottom section being inset relative to an exterior surface of said top section, said top section being dome-shaped, said top section and said bottom section being integrally coupled together, said bottom section being cylindrical, said perimeter wall having a pair of openings extending therein, one of said openings being positioned in a first lateral side of said cover, one of said openings being positioned in a second lateral side of said cover, said first and second lateral sides of said cover being coupled to and extending between a front side and a rear side of said cover;
said front side of said cover having a first notch extending therein, said first notch extending upwardly from said bottom end, said first notch being rectangular;
said rear side of said cover having a second notch extending therein, said second notch being positioned opposite said first notch, said second notch extending upwardly from said bottom end, each of said first notch and said second notch having a respective top edge positioned distally relative to said bottom end of said cover, each of said openings being spaced below said respective top edge of said first and second notches, said second notch being rectangular;
wherein said cover is configured for positioning over a water spigot such that an arm of the water spigot is extendable through said first notch, a spout of the water spigot is extendable through said second notch and a handle of the water spigot is extendable into said interior space of said cover; and
a locking member coupled to said cover wherein said locking member is configured for securing the handle of the water spigot within said interior space of said cover, said locking member comprising a padlock removably coupled to said cover, said padlock including a shackle and a main body coupled together, said shackle being extendable through each of said openings.
